(19) United States
(12) Patent Application Publication
(10) Pub. No.: US 2026/0143359 A1
(43) Pub. Date: May 21, 2026

(54) CELL COVERAGE AND CAPACITY OPTIMIZATION BASED ON ARTIFICIAL INTELLIGENCE

(71) Applicant: ZTE Corporation, Shenzhen (CN)

(72) Inventors: Jiren HAN, Shenzhen (CN); Jiajun CHEN, Shenzhen (CN); Yin GAO, Shenzhen (CN); Dapeng LI, Shenzhen (CN)

(73) Assignee: ZTE Corporation, Shenzhen (CN)

(21) Appl. No.: 19/447,209

(22) Filed: Jan. 13, 2026

Related U.S. Application Data
(63) Continuation of application No. PCT/CN2023/107317, filed on Jul. 13, 2023.

(51) Int. Cl. H04W 24/02; H04L 41/16; H04W 36/24; H04W 56/00; H04W 92/20

(52) U.S. Cl. CPC H04W 24/02; H04L 41/16; H04W 36/249; H04W 56/0015; H04W 92/20

(57) ABSTRACT

This disclosure generally relates to wireless communication networks and is particularly directed to cell coverage and capacity optimization (CCO) in a radio access network in the context of Self-Optimization Network (SON) based on artificial intelligence predictions. For example, radio access network nodes may be configured to assist one another in performing predictive cell CCO for a future time. For cell coverage optimization, such predictive cell optimization may be performed at one radio access network node based on predicted coverage modification information items provided by another radio access network node. The predicted coverage modification information items may be obtain based on network coverage prediction based on artificial intelligence using current and historical network condition, status, and measurement data of current and neighboring cells. As an example, such cell coverage modification may include predictive beam reconfigurations.

### TECHNICAL FIELD

This disclosure is directed generally to wireless communication networks and particularly to cell coverage and capacity optimization in a radio access network based on artificial intelligence predictions.

### BACKGROUND

A radio access network of a cellular wireless network system may be configured as a Self-Optimization Network (SON), which, for example, may be capable of performing cell Coverage and Capacity Optimization (CCO) in real time based on local current network status and radio environment. However, such optimization may be non-ideal without considering network conditions of neighboring cells. In addition, network conditions/status and radio environment may evolve rapidly in time and a CCO based on current network status and radio environment may potentially become stale or out-of-date as soon as it is being made. In other words, mere reactive optimization may be incapable of anticipating cell reconfiguration need due to potential future variation of network conditions.

### SUMMARY

This disclosure generally relates to wireless communication networks and is particularly directed to cell coverage and capacity optimization (CCO) in a radio access network in the context of Self-Optimization Network (SON) based on artificial intelligence predictions. For example, radio access network nodes may be configured to assist one another in performing predictive cell CCO for a future time. For cell coverage optimization, such predictive cell optimization may be performed at one radio access network node based on predicted coverage modification information items provided by another radio access network node. The predicted coverage modification information items may be obtain based on network coverage prediction based on artificial intelligence using current and historical network condition, status, and measurement data of current and neighboring cells. As an example, such cell coverage modification may include predictive beam reconfigurations.

In one example implementation, a method performed by a first wireless network node is disclosed. The method may include obtaining a set of information items for cell coverage and capacity optimization (CCO) at a future time, the set of information items being generated as a prediction based on artificial intelligence (AI); and transmitting to a second wireless network node, via an inter-node interface for control plane messages, the set of information items for the second wireless network node to change coverage configuration at the future time.

In the example implementation above, the set of information items may include a predicted cell coverage modification list. The predicted cell coverage modification list may specify one or more predicted cell coverage modification items each comprising at least one of: a predicted cell coverage state; a prediction Time; a global cell identifier; a cell deployment indicator; a cell replacement information; a predicted synchronization signal block (SSB) coverage modification list; and a cell coverage modification Cause.

In any one of the example implementations above, at least one of the one or more predicted cell coverage modification items includes the predicted SSB coverage modification list, the predicted SSB modification list comprising one or more SSB coverage modification items.

In any one of the example implementations above, at least one of the one or more predicted cell coverage modification items comprises the cell replacement information, the cell replacement information identifying one or more replacement cells.

In any one of the example implementations above, the set of information items are transmitted by the first wireless network node to the second wireless network node in a radio access node (RAN) configuration update message via the inter-node interface.

In any one of the example implementations above, obtaining the set of information items may include receiving one or more alternative coverage configurations from an operation, administration, and management (OAM) function network node; and predicting the set of information items based on AI from the one or more alternative coverage configurations.

In any one of the example implementations above, the method may further include receiving, via the inter-node interface, a RAN configuration update acknowledge message from the second wireless network node.

In any one of the example implementations above, obtaining the set of information items is in response to receiving an AI information request message from the second wireless network node.

In any one of the example implementations above, the AI information request message may include at least one of a prediction time and prediction report characteristics as a basis for the first wireless network node to obtain the set of information items using AI prediction.

In any one of the example implementations above, the prediction report characteristics may include an indicator for indicating to the first wireless network node that the one or more predicted cell coverage modification items for CCO are requested. The indicator is included as a single bit in a bitmap.

In any one of the example implementations above, the method may further include, in response to receiving the AI information request message, determining by the first wireless network node, whether the first wireless network node is capable of providing the set of information items pertaining to the prediction time; and transmitting by the first wireless network node, an AI information response message to the second wireless network node to indicate the prediction time when it is determined that the first wireless network node is capable of providing the set of information items pertaining to the prediction time, or an AI information failure message to the second wireless network node when it is determined that the first wireless network node is not capable of providing the set of information items pertaining to the prediction time, the AI information failure message comprising a failure cause indication.

In any one of the example implementations above, the set of information items are transmitted by the first wireless network node to the second wireless network node in a radio access node (RAN) configuration update message via the inter-node interface.

In any one of the example implementations above, the first wireless network node and the second wireless network node each comprise a next-generation radio access network (NG-RAN) node; and the inter-node interface comprises an Xn interface in a control plane. Alternative, the first wireless network node may be a distributed-unit of a gNB and the second wireless network node may be a central-unit of the gNB and the inter-node interface comprises an F1 interface in a control plane.

In any one of the example implementations above, obtaining the set of information items is in response to receiving a suggested set of predicted CCO information items from the second wireless network node; and the set of information items are obtained by the first wireless network node as a recommendation based on the suggested set of predicted CCO information items from the second wireless network node.

In some of the example implementations above, the suggested set of predicted CCO information items are received by the first wireless network node from the second wireless network node in a RAN configuration update message via the inter-node interface. The set of information items as the recommendation are transmitted by the first wireless network node to the second wireless network node in a RAN configuration update acknowledge message. The first wireless network node and the second wireless network node each comprise a next-generation radio access network (NG-RAN) node; and the inter-node interface comprises an Xn interface in a control plane.

In any one of the example implementations above, obtaining the set of information items is in response to receiving a predicted CCO assistant information items from the second wireless network node. The predicted CCO assistance information items may include at least one of predicted CCO issue detection information; information on affected cells and beams; and a prediction time.

In some of the example implementations above, the method may further include acknowledging receiving the predicted CCO assistance information items to the second wireless network node via the inter-node interface before transmitting the set of information items to the second wireless network node. The method may further include receiving an acknowledgement as a configuration update knowledge message from the second wireless network node via the inter-node interface after sending the set of information items.

In some of the example implementations above, the first wireless network node includes a distributed-unit of a wireless base station whereas the second wireless network node includes a central-unit of the wireless base station.

In another example implementation, a method performed by a second wireless network node assisted by a first wireless network node is disclosed. The method may include receiving, from the first wireless network node, a set of information items for cell CCO at a future time, the set of information items being generated as a prediction based on AI; and changing coverage configuration of the second wireless network node based on the set of information items received from the first wireless network node. The various example implementations above with actions taken by the second wireless network node may also be additionally included in this example implementation.

The wireless network node of any one of the methods above is further disclosed. The wireless network node may include a processor and a memory, wherein the processor is configured to read computer code from the memory to cause the wireless terminal to perform the method of any one of the methods above.

A non-transitory computer-readable program medium with computer code stored thereupon is further disclosed. The computer code, when executed by a processor of the wireless network node of any one of the methods above, is configured to cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations/terminals or User Equipments (UEs) and a wireless access network node in communication with one another via an over-the-air radio communication interface.

FIG. 3 shows an example radio access network (RAN) architecture.

FIG. 4 shows an example communication protocol stack in a wireless access network node or wireless terminal device including various network layers.

FIG. 5 illustrates an example messaging flow between wireless access network nodes for predictive cell coverage and capacity optimization.

FIG. 6 illustrates another example messaging flow between wireless access network nodes for predictive cell coverage and capacity optimization.

FIG. 7 illustrates another example messaging flow between wireless access network nodes for predictive cell coverage and capacity optimization.

FIG. 8 illustrates another example messaging flow between wireless access network nodes for predictive cell coverage and capacity optimization.

FIG. 9 illustrates yet another example messaging flow between wireless access network nodes for predictive cell coverage and capacity optimization.

### DETAILED DESCRIPTION

The technologies underlying and examples of implementations and/or embodiments described in this disclosure can be used for predictive cell Coverage and Capacity Optimization (CCO) in Self-Optimization Network (SON) involving radio access network nodes in a wireless cellular communication network. The term “over-the-air interface” is used interchangeably with “air interface” or “radio interface” in this disclosure. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

In summary, the disclosure below generally relates to wireless communication networks and is particularly directed to cell CCO in the context of SON based on artificial intelligence predictions. For example, radio access network nodes may be configured to assist one another in performing predictive cell CCO for a future time. For cell coverage optimization, such predictive cell optimization may be performed at one radio access network node based on predicted coverage modification information items provided by another radio access network node. The predicted coverage modification information items may be obtain based on network coverage prediction based on artificial intelligence using current and historical network condition, status, and measurement data of current and neighboring cells. As an example, such cell coverage modification may include predictive beam reconfigurations.

### Wireless Communication Networks

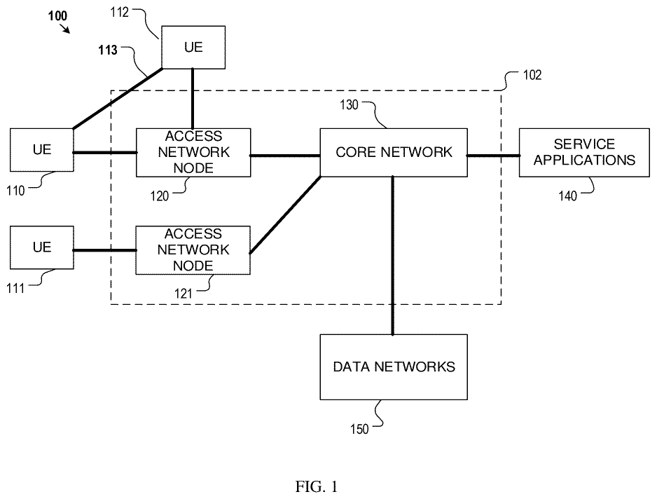

An example wireless communication network, shown as 100 in FIG. 1, may include wireless terminal devices or user equipment (UE) 110, 111, and 112, a carrier network 102, various service applications 140, and other data networks 150. The wireless terminal devices or UEs, may be alternatively referred to as wireless terminals. The carrier network 102, for example, may include access network nodes 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access network nodes 120 and 121 may be configured as various wireless access network nodes (WANNs, alternatively referred to as wireless base stations) to interact with the UEs on one side of a communication session and the core network 130 on the other. The term “access network” may be used more broadly to refer a combination of the wireless terminal devices 110, 111, and 112 and the access network nodes 120 and 121. A wireless access network may be alternatively referred to as Radio Access Network (RAN). The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the example wireless communication network of 100 of FIG. 1, the UEs may communicate with one another via the wireless access network. For example, UE 110 and 112 may be connected to and communicate via the same access network node 120. The UEs may communicate with one another via both the access networks and the core network. For example, UE 110 may be connected to the access network node 120 whereas UE 111 may be connected to the access network node 121, and as such, the UE 110 and UE 111 may communicate to one another via the access network nodes 120 and 121, and the core network 130. The UEs may further communicate with the service applications 140 and the data networks 150 via the core network 130. Further, the UEs may communicate to one another directly via side link communications, as shown by 113.

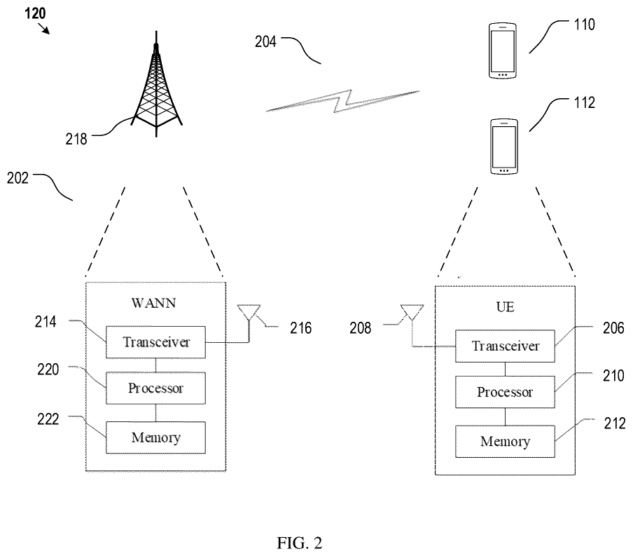

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a wireless base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station of a 5G gNB, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

The core network 130 of FIG. 1 may include various network nodes geographically distributed and interconnected to provide network coverage of a service region of the carrier network 102. These network nodes may be implemented as dedicated hardware network nodes. Alternatively, these network nodes may be virtualized and implemented as virtual machines or as software entities. These network nodes may each be configured with one or more types of network functions which collectively provide the provisioning and routing functionalities of the core network 130.

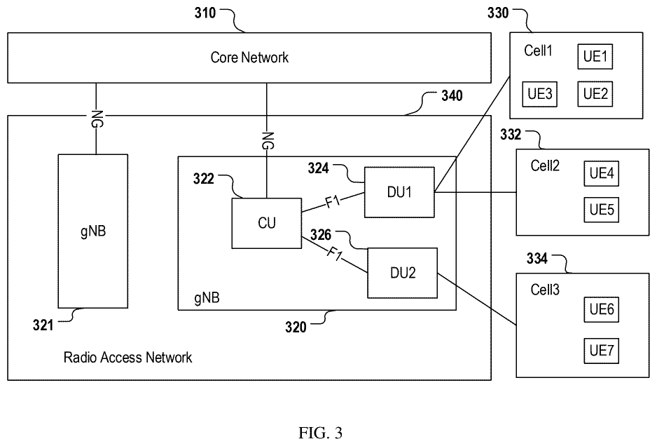

Returning to wireless radio access network (RAN), FIG. 3 illustrates an example RAN 340 in communication with a core network 310 and wireless terminals UE1 to UE7. The RAN 340 may include one or more various types of wireless base station or WANNs 320 and 321 which may include but are not limited to gNB, eNodeB, NodeB, or other type of base stations (for simplicity, only gNBs are illustrated in FIG. 3). The RAN 340 may be backhauled to the core network 310 via, for example, NG interfaces.

The WANNs may of FIG. 3 may be configured to communicate with one another via inter-node interfaces. For example, the gNBs may communicate with one another via an Xn interface. For another example, 5G base stations gNBs may communicate with LTE base stations such as NodeBs or eNodeBs via an X2 interface. In some example implementations, the WANN 320, for example, may further include multiple separate access network nodes in the form of a Central Unit (CU) 322 and one or more Distributed Units (DUs) 324 and 326. In some embodiments, the CU may be a gNB Central Unit (gNB-CU), and the DU may be a gNB Distributed Unit (gNB-DU). The CU 322 may be connected with DU1 324 and DU2 326 via various inter-node interfaces, for example, an F1 interface. Each of the various inter-node interfaces, may further be delineated into a control-plane interface and a user-plane interface. For a specific example, the F1 interface between a CU and a DU may further include an F1-C interface and an F1-U interface, which may be used to carry control plane information and user plane data, respectively. Likewise, the Xn or X2 interfaces may include an Xn-C and Xn-U or X2-C and X2-U interfaces. For purpose of this disclosure and the claims thereof, each CU and DU are considered separate access network node. The F1 interface thus falls within a definition of inter-node communication interface. In addition, while the various implementations described below are provided in the context of a 5G cellular wireless network, the underlying principles described herein are applicable to other types of radio access networks including but not limited to other generations of cellular network, as well as Wi-Fi, Bluetooth, ZigBee, and WiMax networks.

The UEs may be connected to the network via the WANNs 320 over an air interface. The UEs may be served by at least one cell. Each cell is associated with a coverage area. These cells may be alternatively referred to as serving cells. The coverage areas between cells may partially overlap. Each UE may be actively communicating with at least one cell while may be potentially connected or connectable to more than one cell. In the example of FIG. 1, UE1, UE2, and UE3 may be served by cell1 330 of the DU1, whereas UE4 and UE5 may be served by cell2 332 of the DU1, and UE6 and UE7 may be served by cell3 associated with DU2. In some implementations, a UE may be served simultaneously by two or more cells. Each of the UE may be mobile and the signal strength and quality from the various cells at the UE may depend on the UE location and mobility.

In some example implementations, the cells shown in FIG. 3 may be alternatively referred to as serving cells. The serving cells may be grouped into serving cell groups (CGs). A serving cell group may be either a Master CG (MCG) or Secondary CG (SCG). Within each type of cell groups, there may be one primary cell and one or more secondary cells. A primary cell in a MSG, for example, may be referred to as a PCell, whereas a primary cell in a SCG may be referred to as PScell. Secondary cells in either an MCG or an SCG may be all referred to as SCell. The primary cells including PCell and PScell may be collectively referred to as spCell (special Cell). All these cells may be referred to as serving cells or cells. The term “cell” and “serving cell” may be used interchangeably in a general manner unless specifically differentiated. The term “serving cell” may refer to a cell that is serving, will serve, or may serve the UE. In other words, a “serving cell” may not be currently serving the UE. While the various embodiment described below may at times be referred to one of the types of serving cells above, the underlying principles apply to all types of serving cells in both types of serving cell groups.

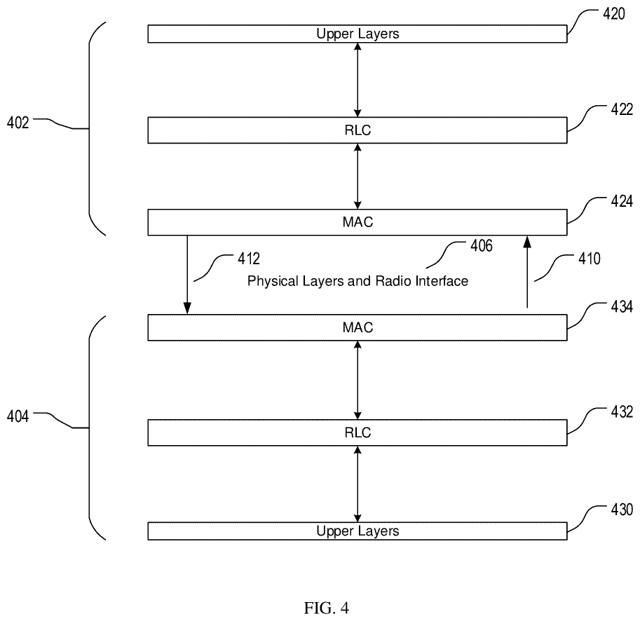

FIG. 4 further illustrates a simplified view of the various network layers involved in transmitting user-plane PDUs from a transmitting device 402 to a receiving device 404 in the example wireless access network of FIGS. 1-3. FIG. 4 is not intended to be inclusive of all essential device components or network layers for handling the transmission of the PDUs. FIG. 4 illustrates that the data packaged by upper network layers 420 at the transmitting device 402 may be transmitted to corresponding upper layer 430 (such as radio resource control or RRC layer) at the receiving device 304 via Packet Data Convergence Protocol layer (PDCP layer, not shown in FIG. 4) and radio link control (RLC) layer 422 and of the transmitting device, the physical (PHY) layers of the transmitting and receiving devices and the radio interface, as shown as 406, and the media access control (MAC) layer 434 and RLC layer 432 of the receiving device. Various network entities in each of these layers may be configured to handle the transmission and retransmission of the PDUs.

In FIG. 4, the upper layers 420 may be referred as layer-3 or L3, whereas the intermediate layers such as the RLC layer and/or the MAC layer and/or the PDCP layer (not shown in FIG. 4) may be collectively referred to as layer-2, or L2, and the term layer-1 is used to refer to layers such as the physical layer and the radio interface-associated layers. In some instances, the term “low layer” may be used to refer to a collection of L1 and L2, whereas the term “high layer” may be used to refer to layer-3. In some situations, the term “lower layer” may be used to refer to a layer among L1, L2, and L3 that are lower than a current reference layer. Control signaling may be initiated and triggered at each of L1 through L3 and within the various network layers therein. These signaling messages may be encapsulated and cascaded into lower layer packages and transmitted via allocated control or data over-the-air radio resources and interfaces. The term “layer” generally includes various corresponding entities thereof. For example, a MAC layer encompasses corresponding MAC entities that may be created. The layer-1, for example, encompasses PHY entities. The layer-2, for another example encompasses MAC layers/entities, RLC layers/entities, service data adaptation protocol (SDAP) layers and/or PDCP layers/entities.

### Self-Optimization Network (SON) and Cell Coverage and Capacity Optimization (CCO)

Configuration of various RAN parameters that affect cell coverage and/or service capacity at access or cellular level in the wireless network systems depicted in FIGS. 2 and 3 is critical for providing reliable wireless connections and services to various mobile or fixed wireless terminals. Such configurations closely relate to, for example, spatial, frequency, time, and power arrangement of the over-the-air radio resources, and thus directly affect the cellular coverage of terminal devices and the service capacity of the radio access network.

Such cellular configurations may be initially determined according to expected/estimated network traffic and volume of terminal devices when the wireless access networks are deployed. Such cellular configurations may be modified and redeployed or reconfigured at later times when the network traffic and service conditions change substantially. In traditional implementations, changes or redeployment to effectuate cellular coverage or capacity of deployed access networks may be infrequent (and often untimely) and thus may be carried out holistically but manually at network system level. Such changes, for example, may be centrally planned and commanded from the core network side.

In some example implementations, such cellular configuration modifications may be performed automatically in near real-time and in a reactive manner according to measured or derived cellular network conditions and radio environment. Such real-time reactive adaptation of cellular network configuration may be effectuated within the radio access network with little involvement of the core network. A wireless network system with access networks that are capable of real-time automatic reactive cellular configuration optimization may be referred to as a Self-Optimization Network (SON). The automatic cellular configuration optimization, for example, may be related to cellular or cell Coverage and Capacity Optimization (CCO). As such, an objective of CCO in the context of SON is to adaptively provide desired coverage and capacity in targeted coverage areas and to minimize interferences and maintain an acceptable quality of service in an autonomous manner. Such an automatic self-optimization capability thus allows for more real-time adaptation of a cell configuration according to network traffic volume and geographic distribution of the traffic, device volume and distribution, radio environment, and the like of the cell and its neighboring cells.

### Predictive Cell CCO Based on Artificial Intelligence

In some example implementations, rather than reactive adaptation, RAN configuration modifications related to cellular coverage and capacity may be automatically predicted for a future time based on anticipated network traffic and radio environment. Such anticipatory RAN configuration modifications can be timely performed and effectuated at the corresponding future time.

The prediction of future RAN configuration modifications, may be based on current network traffic and conditions as measured in conjunction with historical network traffic data pattern and cellular configurations of a current cell, and its neighboring cells. Such prediction may not be formulistic and may not follow a particular deterministic algorithm. In other words, correlations between RAN configuration modifications at a future time with current and historical network traffic and configuration data pattern may exist but may not be explicitly known. Such correlations may thus be derived based on predictive Artificial Intelligence (AI) models including but not limited to pre-trained neural networks and/or other Machine-Learning (ML) models.

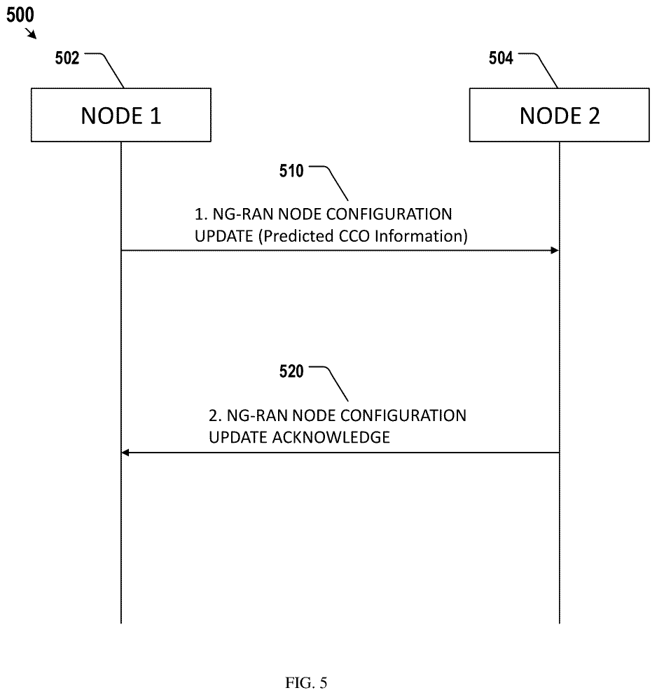

The output of such AI or ML models, for predictive cellular coverage optimization purposes, for example, may be a predicted cell coverage modification list. Data structures for a predicted cell coverage modification list may be predefined and may be used by a RAN node to implement CCO in the context of SON. An example of such a data structure is given in further detail below in relation to example implementations of FIGS. 5-9. While the various implementations below focus on cellular coverage aspect of the CCO, the underlying principles apply to the cellular capacity aspect of the CCO as well. The disclosures below are not intended as being limited to cellular coverage optimization, even though only “coverage optimization” is explicitly mentioned at times.

In some example implementations, as described in further detail below, one RAN node may be configured to assist another RAN node in predictive CCO. For example, a first RAN node may be configured to obtain/generate and provide a predicted cell coverage modification list for a particular future time with respect to a second RAN node. Upon receiving the predicted cell coverage modification list, the second RAN node may then perform CCO based on the received predicted cell coverage modification list at the corresponding future time.

Such inter-node collaborative approach for predictive cell coverage and capacity optimization may be desired in several aspects. For example, some RAN node may be more computationally advanced and thus are more suitable for performing AI predictions on behalf of other less computationally capable RAN nodes for those RAN nodes to perform CCO. For another example, some RAN nodes may have more convenient access to network traffic data measurement and historical network data and may thus be in better position to perform AI prediction of cell coverage modification list for other RAN nodes. For yet another example, optimization at a particular cell may heavily depend on network conditions of its neighboring cells and RAN nodes associated with those neighboring cells may be in a better position to obtain or generate the predicted cell coverage modification list.

For the inter-node collaborative approach in predictive cell CCO, the communication of the cell coverage modification list data structure and/or other information items may, for example, rely on the inter-node communication interface described above in relation to FIG. 3. The specific example implementations of the messaging processes and procedures are described in further detail below in relation to FIGS. 5-9.

### Cell Coverage Modification List

In some example implementations, the predicted cell coverage and/or capacity modification data structure may be communicated between RAN nodes via the inter-node interface(s) described above in relation to FIG. 3. Such predicted cell coverage and/or capacity data structure may be included as an information data structure in an inter-node message. Such inter-node message may be implemented as a control message exchanged via a control plane of the corresponding inter-node interface in the radio access network. In some other implementations, such information data structure may be included in a data message communicated via a user plane of the inter-node interface instead.

An example hierarchical predicted cell coverage modification data stricture containing various example information elements is shown below in Table 1. The symbols “>”, “>>”, “>>>”, and “>>>>” are used to designate layered hierarchical relationships between the various information elements. The “Presence” column indicates whether a particular information element is mandatory (“M”) or optional (“O”). The specific “Presence” designations in Table 1 are merely shown as examples. Each row of the “Range” column specifies a number of items of the corresponding information element. The “IE type and reference” column specifies data type of the corresponding information elements. Notes that describe various aspects of each of the information elements are included in the “Semantics description” column.

TABLE 1
Example predicted cell coverage modification Data Structure

| IE/Group | | | IE type and | |
|---|---|---|---|---|
| Name | Presence | Range | reference | Semantics description |
| Predicted | | 0 . . . 1 | | List of cells with predicted |
| Coverage | | | | modified coverage is either |
| Modification | | | | present of not present (as |
| List | | | | indicated by the “Range”, where |
| | | | | “0” indicates that no cell |
| | | | | coverage modification list is not |
| | | | | present (NULL list), and “1” |
| | | | | indicates that the cell coverage |
| | | | | modification list is present and |
| | | | | listed below. |
| > Predicted | | 0 . . . | | There may be multiple predicted |
| Coverage | | <max_noof_Cells_{—} | | coverage modification items. For |
| Modification | | in_NG-RAN node> | | example, each of coverage |
| Item | | | | modification items are described |
| | | | | by the information elements |
| | | | | below at the “>>” level and |
| | | | | below. Each coverage |
| | | | | modification item, for example, |
| | | | | correspond to one cell. As |
| | | | | such, the maximum number of |
| | | | | these data items in the cell |
| | | | | coverage modification list is |
| | | | | limited by the maximum number |
| | | | | of cells in the RAN, as indicated |
| | | | | by the “Range” property. |
| >>Global | M | | Global NG-RAN | NG-RAN Cell Global Identifier |
| NG-RAN | | | Cell Identity | of the cell to be modified. |
| Cell Identity | | | | Designation of “NG” is merely |
| (or NR-CGI) | | | | used as an example. This is |
| | | | | applicable to other type of RAN |
| | | | | nodes |
| >>Predicted | M | | INTEGER | For example, value ‘0’ for this |
| Cell | | | (0 . . . 63, . . . ) | information element indicates |
| Coverage | | | | that the cell is inactive. Other |
| State | | | | values Indicates that the cell is |
| | | | | active and also indicates the |
| | | | | coverage configuration of the |
| | | | | concerned cell. Each value |
| | | | | corresponds to a predefined cell |
| | | | | coverage state that a cell can be |
| | | | | configured to. |
| >> | O | | See the details in | The time information for the |
| Prediction | | | additional | Predicted Cell Coverage State |
| Time | | | disclosure below | (e.g., a future time period that |
| | | | in Table 2 | the predicted cell coverage state |
| | | | | above applies to). |
| >>Cell | O | | ENUMERATED | Indicates the predicted Cell |
| Deployment | | | (pre-change- | Coverage State is planned to be |
| Status | | | notification, . . . ) | used at the next reconfiguration, |
| Indicator | | | | e.g., “0” indicate that the |
| | | | | predicted cell coverage is not to |
| | | | | be deployed at the next |
| | | | | reconfiguration whereas “1” |
| | | | | indicate planned deployment at |
| | | | | the next reconfiguration. |
| >>Cell | C-if_Cell_Deployment_{—} | | | |
| Replacing | Status_Indicator_Present | | | |
| Info | | | | |
| >>> | | 0 . . . | | |
| Replacing | | <max_noof_{—} | | |
| Cells | | Cells_In_{—} | | |
| | | NG-RAN node> | | |
| >>>>Global | | | Global NG-RAN | NG-RAN Cell Global Identifier |
| NG-RAN | | | Cell Identity | of a cell that may replace all or |
| Cell Identity | | | | part of the coverage of the cell to |
| | | | | be modified. |
| >>Predicted | | 0 . . . 1 | | For each cell, indicate whether a |
| SSB | | | | List of Synchronization Signal |
| Coverage | | | | Block (SSB) beams with |
| Modification | | | | modified coverage is present or |
| List | | | | not (e.g., “0” represents a NULL |
| | | | | list whereas “1” represents an |
| | | | | existence of the list below). |
| >>> | | 0 . . . | | The number of data items in the |
| Predicted | | <Max_Noof_SSB_Areas> | | list of SSB coverage |
| SSB | | | | modification is limited buy a |
| Coverage | | | | maximum number SSB areas in |
| Modification | | | | a corresponding cell. |
| Item | | | | |
| >>>>SSB | M | | INTEGER | Identifier of the SSB beam to be |
| Index | | | (0 . . . 63) | modified using SSB index. |
| >>>> | M | | INTEGER | For each SSB index, value ‘0’ |
| Predicted | | | (0 . . . 15, . . . ) | indicates that the corresponding |
| SSB | | | | SSB beam is inactive. Other |
| Coverage | | | | values Indicates that the SSB |
| State | | | | beam is active and also indicates |
| | | | | the coverage configuration of the |
| | | | | concerned SSB beam. Each |
| | | | | non-zero value maps to a |
| | | | | predefined SSB beam coverage |
| | | | | configuration. |
| >>>> | O | | | The time information for the |
| Prediction | | | | Predicted SSB Coverage State |
| Time | | | | for each SSB index. |
| >>Coverage | O | | ENUMERATED | Indicates the reason for the |
| Modification | | | (coverage, cell | coverage modification in NG- |
| Cause | | | edge capacity, . . . ) | RAN node for each cell. |

To be more specific, the “Predicted Cell Coverage State” above for each of the cells in the list indicates the coverage configuration of the concerned cell predicted for a future time as indicated in the information element of “Predicted Time”. The “Prediction Time” information element indicates the time information for the “Predicted Cell Coverage State”, including at least one of a start time of the prediction, a time duration for the prediction and an end time of the prediction. The “Cell Deployment Indicator” information element for each of the cells in the list indicates whether the predicted Cell Coverage State is to be used at the next reconfiguration. The “Cell Replacing Info” information element for each of the cells in the list includes ID of a cell that may replace all or part of the coverage of the cell to be modified. The “Predicted SSB Coverage Modification List” includes at least one of the “Predicted SSB Coverage State”, “Predicted Time”, “SSB Index” information elements as indicated in Table 1 above. The “Predicted SSB Coverage State” may indicate the coverage configuration of the concerned SSB beam at the future “Predicted Time”. The “Coverage Modification Cause” information element indicates that the predicted CCO at the future time is caused by coverage issue or the cell edge capacity issue.

A further example of the information items being included in the “prediction time” information element is shown below in Table 2. The example Prediction Time information element essentially contains a start time, a time duration, and/or an end time of a future time period for the prediction.

TABLE 2
Prediction Time Information Element

| | | | | |
|---|---|---|---|---|
| | | | IE type and | |
| IE/Group Name | Presence | Range | reference | Semantics description |

| | | |
|---|---|---|
| Start Time of | M | The start time of the coverage status to |
| Prediction | | be predicted. |
| Time Duration | O | The duration of time the coverage |
| of Prediction | | status to be predicted. |
| End Time of | O | The end time of the coverage status to |
| Prediction | | be predicted. |

### Inter-Node Predictive Cell CCO Messaging in RAN

An inter-node exchange of predicted cell coverage optimization information between wireless communication nodes, such as RAN nodes, may be achieved in various example manners as described below.

Inter-Node Transmission of Predicted CCO information Using RAN Node Configuration Update Messaging Procedure and Mechanism

An example implementation for exchanging predicted CCO information between RAN nodes is shown in as messaging procedure 500 in FIG. 5. The implementation 500 of FIG. 5 essentially enhances a traditional inter-node procedure used for CCO (such as a RAN Node Configuration Update procedure, e.g., NG-RAN Node Configuration Update Procedure). In FIG. 5, RAN node 1 labeled as 502 may be configured to assist RAN node 2 labeled as 504 to perform predictive CCO at a future time.

For example, the procedure 500 may include Step 0 (not explicitly shown in FIG. 5), in which RAN node 502 receives or obtains alternative coverage configuration from, for example, an Operation, Administration, and Maintenance (OAM) node of the core network, and obtain or otherwise generate the predicted CCO information via AI/ML prediction. Such predicted CCO information may be generated as a data structure or format as indicated above in Table 1.

In Step 1 (510 of FIG. 5), RAN node 502 may send the predicted CCO information to the RAN node 504 via a RAN NODE CONFIGURATION UPDATE message. The predicted CCO information may be included in the RAN NODE CONFIGURATION UPDATE message as the Predicted Coverage Modification List of Table 1, which includes at least one of the Predicted Cell Coverage State, Prediction Time, Global Cell ID, Cell Deployment Indicator, Cell Replacing Info, Predicted SSB Coverage Modification List, and Coverage Modification Cause, all for each of one or more cells of RAN node 504.

In Step 2 (520 of FIG. 5), after receiving the predicted CCO information by RAN node 504 from RAN node 502, the RAN node 504 may further send a RAN NODE CONFIGURATION UPDATE ACKNOWLEDGE message back to RAN node 502.

With the Predicted CCO Information from the RAN node 502, the RAN node 504 may then proceed to adjusting/optimizing the coverage of the related cell(s) to enhance cell coverage or cell edge capacity for UEs in the network according to the predicted CCO information for the specified future time. The coverage/capacity optimization may include adjustments to beam configuration, frequency bands allocation, ratio power levels, and the like.

In the example implementation above, the RAN nodes 502 and 504 may both be NG-RAN nodes. Correspondingly, the message exchange between these RAN nodes may be implemented as NG-RAN NODE CONFIGURATION UPDATE message and NG-RAN NODE CONFIGURATION UPDATE ACKNOWLEDGE message.

In some other implementations, the first wireless network node may be a DU of a base station and the second wireless network node may be a CU of the base station and the inter-node interface comprises an F1 interface in a control plane.

For example, the predicted CCO information as constructed following the data structure of Table 1 may be included in an NG-RAN NODE CONFIGURATION UPDATE message from one NG-RAN node to another neighboring NG-RAN node via an instance of the example Xn-C inter-node interrace. Likewise, the other neighboring NG-RAN node may acknowledge the receipt of the predicted CCO information via an NG-RAN NODE CONFIGURATION UPDATE ACKNOWLEDGE message.

Inter-Node Transmission of Predicted CCO information Transmission Using an AI/ML Information Reporting Procedure

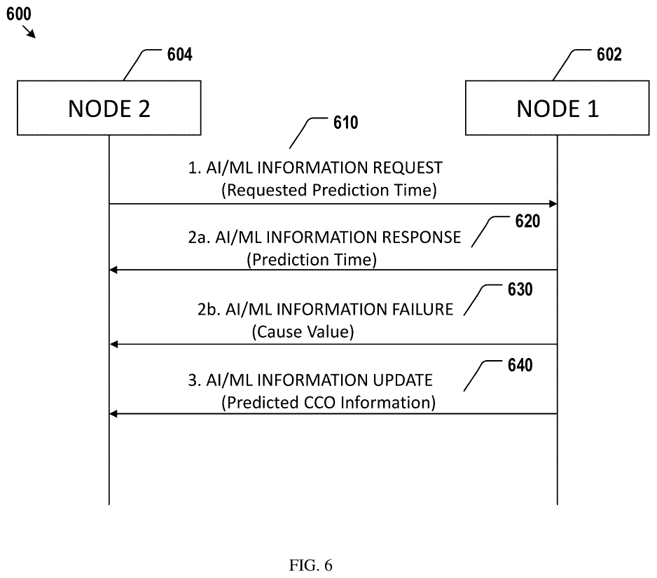

Another example implementation for exchanging predicted CCO information between RAN nodes is shown as messaging procedure 600 in FIG. 6. The implementation 600 of FIG. 6 essentially employs a specific AI/MI Information Reporting Messaging procedure for inter-node exchange of predicted CCO information. In FIG. 6, RAN node 1 labeled as 602 may be configured to assist RAN node 2 labeled as 604 to perform predictive CCO at a future time and at a request by RAN node 604. The example procedure of FIG. 6 may include AI/MI information reporting initiation and AI/MI information reporting transmission procedures.

For example, in Step 1, indicated as 610 in FIG. 6, RAN node 604 may send an AI/ML INFORMATION REQUEST message to the RAN node 602 to request predicted CCO information from RAN node 602 for a future prediction time. The AI/ML INFORMATION REQUEST message thus may include at least one of requested Prediction Time and Report Characteristics.

The requested Prediction Time may be included to indicate the time information for the predictive CCO at RAN node 604. Information items included in an example requested Prediction Time are shown in Table 2 above. For example, the requested Prediction Time may include at least one of the start time of the prediction, the time duration for the prediction and the end time of the prediction. The Report Characteristics in the AI/ML INFORMATION REQUEST message above may include, for example, an indicator to indicate that the subject matter pertaining to the request relates to predicted coverage information such as a predicted coverage modification list. The indicator may be binary and used for indicating that the request is for CCO prediction information when the indicator is “1”. Such indicator may be part of bitmap that may be used to additionally indicate other characteristics of the requests.

In Step 2a, labeled as 620 of FIG. 6, if RAN node 602 is capable of providing the predicted CCO information requested by RAN node 604 upon receiving the request in Step 610, it may send an AI/ML INFORMATION RESPONSE message to RAN node 604. This response message may include the Prediction Time information for predicted CCO information. By including the Prediction time information, RAN node 602 effectively acknowledges to RAN node 604 its capability to obtain or generate the requested predicted CCO information. Otherwise, as shown in Step 2b, labeled in FIG. 6 as 630, if RAN node 602 is not able to provide the predicted CCO information requested by the RAN node 604, RAN node 602 may then send an AI/ML INFORMATION FAILURE message to the RAN node 604. This failure message may include a cause value to indicate to RAN node 604, for example, that the predicted CCO information is not available or the predicted CCO information cannot be provided by RAN node 602.

Further in Step 3, labeled as 640 in FIG. 6, if RAN node 602 is able to provide the predicted CCO information requested by RAN node 604, RAN node 602 may further obtain/generate the predicted CCO information and send an AI/ML INFORMATION UPDATE message to RAN node 604 to provide the predicted CCO information. Such predicted CCO information, for example, may include the Predicted Coverage Modification List described in Table 1 above.

Upon receiving the Predicted CCO Information from RAN node 602, RAN Node 604 is then able to adjust its coverage of the related cells or SSB beams in these cells to optimize cell coverage and/or cell edge capacity for the specified future time.

The example AI/ML INFORMATION REQUEST, the AI/ML INFORMATION RESPONSE, the AI/ML INFORMATION FAILURE, and the AI/ML INFORMATION UPDATE messages may be designed as inter-node exchange messages. RAN nodes 602 and 604 above, for example, may be both NR-RAN nodes. Correspondingly, the inter-node message above may be designed for exchange via the Xn interface described above. For example, such message may be exchanged via the Xn-C interface. For another example, RAN node 604 may be a gNB-CU, whereas RAN node 602 may be a gNB-DU, or the other way around. The exchange of the messages between the gNB-CU and the gNB-DU may thus correspondingly be communicated via the F1 interface (such as the F1-C interface) described above.

Example data structures for the AI/ML INFORMATION REQUEST, the AI/ML INFORMATION RESPONSE, the AI/ML INFORMATION FAILURE, and the AI/ML INFORMATION UPDATE messages are provided below in Tables 3, 4, 5, and 6, respectively.

TABLE 3
Example AI/ML INFORMATION REQUEST Message (Node 2 to Node 1)

| | | | | |
|---|---|---|---|---|
| | | | IE type and | |
| IE/Group Name | Presence | Range | reference | Semantics description |

>>Other IEs have been skipped<<

| | | | |
|---|---|---|---|
| Report | O | BITSTRING | Each position in the bitmap |
| Characteristics | | (SIZE(32)) | indicates the object the NG-RAN |
| | | | node 1 is requested to report. |
| | | | Xth Bit = Predicted Coverage |
| | | | Modification List |
| Requested | O | Prediction | The Prediction Time for the |
| Prediction Time | | Time, which | CCO information prediction in |
| | | is given as | Node 1 requested by Node 2 |
| | | below | |

TABLE 4
Example AI/ML INFORMATION RESPONSE Message (Node 1 to Node 2)

| | | | | |
|---|---|---|---|---|
| | | | IE type and | |
| IE/Group Name | Presence | Range | reference | Semantics description |

>>Other IEs have been skipped<<

| | | |
|---|---|---|
| Prediction Time | O | The Prediction Time for the |
| | | CCO information prediction in |
| | | Node 1 |

TABLE 5
Example AI/ML INFORMATION FAILURE Message (Node 1 to Node 2)

| | | | | |
|---|---|---|---|---|
| | | | IE type and | |
| IE/Group Name | Presence | Range | reference | Semantics description |

>>Other IEs have been skipped<<

| | | |
|---|---|---|
| Cause | M | indicates that the predicted CCO |
| | | information in Node 2 is not |
| | | available or the predicted CCO |
| | | information in Node cannot be |
| | | provided. |

TABLE 6
Example AI/ML INFORMATION UPDATE Message (Node 1 to Node 2)

| IE/Group | | | IE type and | |
|---|---|---|---|---|
| Name | Presence | Range | reference | Semantics description |
| Cell AI/ML | | 0 . . . 1 | | |
| Info Result | | | | |
| >Cell AI/ML | | 1 . . . | | Similar to information |
| Info Result | | <max_Noof_{—} | | elements under “Predicted |
| Item | | Cells_in_NG- | | Coverage Modification |
| | | RAN_node> | | Item” of Table 1. |
| >>Cell ID | M | | Global NG-RAN | |
| | | | Cell Identity | |

### Inter-Node Transmission of Predicted CCO Information Transmission Via Negotiation Between RAN Nodes

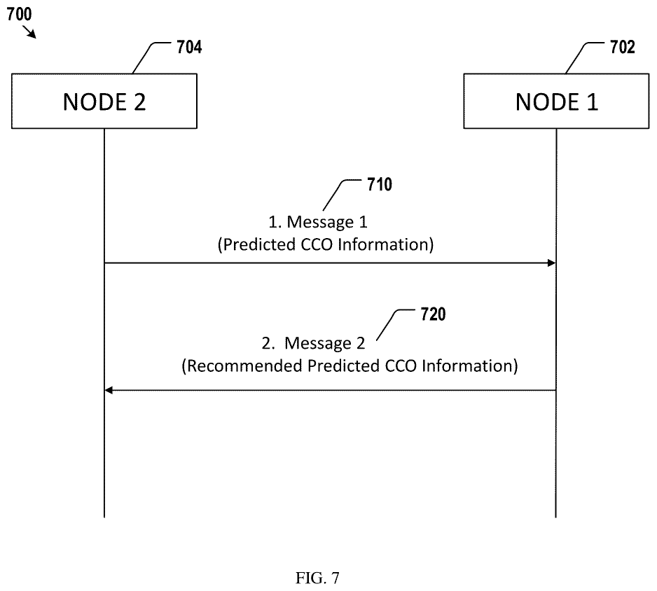

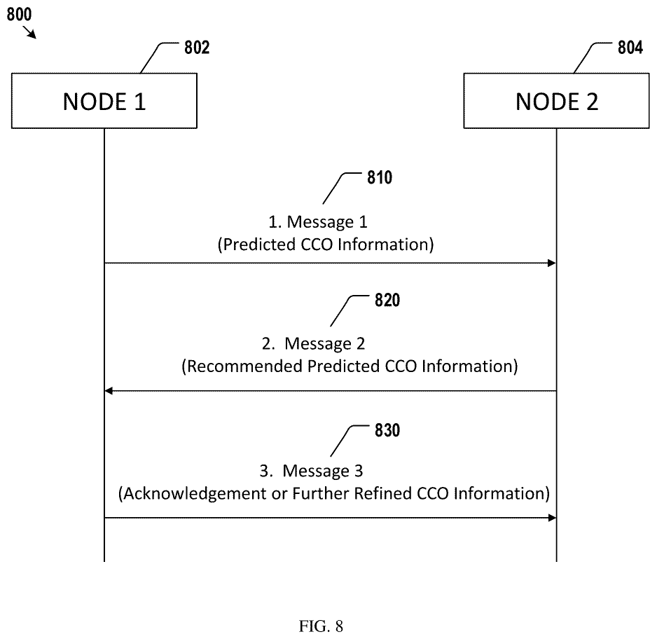

Other example implementations for exchanging predicted CCO information between RAN nodes via example inter-node negotiation processes are shown as messaging procedures 700 and 800 in FIGS. 7 and 8. The negotiation procedure enables CCO prediction information proposal and modification for improved cell coverage and/or capacity optimization. In both FIGS. 7 and 8, RAN node 2 (labeled as node 704 and 804) is to perform its cell coverage and/or capacity optimization by negotiating CCO prediction information with RAN node 1 (labeled as node 702 and 802).

In the example messaging procedure 700, RAN node 704 may send its predicted CCO information to RAN node 702, and RAN Node 702 may either reject the proposed predicted CCO information and send revised or modified recommended predicted CCO information back to RAN node 704.

Specifically, in Step 1 of FIG. 7, labeled as 710, RAN node 704 may be configured to send proposed predicted CCO information to RAN node 702 via Message 1. Message 1, for example, may be implemented via the inter-node interface as the RAN NODE CONFIGURATION UPDATE message described above. The proposed predicted CCO information may be included in Message 1 in a format or data structure similar to that shown in Table 1 above. Such predicted CCO information may be intended for RAN node 704 to use for performing CCO of its cells.

In Step 2 of FIG. 7, shown as 720, if the RAN node 702 determines that the proposed predicted CCO information as received from RAN node 704 is not reasonable, it may reject the proposed predicted CCO information and generate/obtain/provide at least one of the following information to the RAN Node 702 via Message 2: its recommended/revised predicted CCO information and a cause value for the recommendation/revision. The content of the recommended predicted CCO information, for example, may be similar to data structure for predicted CCO information of Table 1 above. The cause value for the recommendation may indicate the reason(s) why RAN node 702 has rejected the proposed predicted CCO information for RAN node 704 received from the RAN node 704 in Message 1 of Step 710. The reasons may be that the proposed predicted information may still have coverage and/or capacity issues in the future time as indicated.

Upon receiving the recommended Predicted CCO Information from the RAN node 702, RAN node 704 may then be able to take the suggestion of RAN node 702 into account and optimize the coverage of the related cells or SSB beams accordingly, with improved understanding of its neighbor nodes (such as RAN node 702).

In the example implementation of FIG. 7, Message 1 may be implemented as RAN NODE CONFIGURATION UPDATE message or AI/ML CONFIGURATION UPDATE message or AI/ML INFORMATION REQUEST message described above. Accordingly, Message 2 may be implemented as RAN NODE CONFIGURATION UPDATE ACKNOWLEDGE message or AI/ML CONFIGURATION UPDATE ACKNOWLEDGE message or AI/ML INFORMATION RESPONSE message as described above. Specifically, the RAN nodes 702 and 704 may both be NG-RAN nodes. As such, Message 1 may be implemented as NG-RAN NODE CONFIGURATION UPDATE message or AI/ML CONFIGURATION UPDATE message or AI/ML INFORMATION REQUEST message described above. Accordingly, Message 2 may be implemented as NG-RAN NODE CONFIGURATION UPDATE ACKNOWLEDGE message or AI/ML CONFIGURATION UPDATE ACKNOWLEDGE message or AI/ML INFORMATION RESPONSE message as described above.

In the example messaging procedure 800, RAN node 804 may need to perform future CCO. Unlike the example implementation of FIG. 7, its neighboring node RAN node 802 may be the initial proposer for the predicted CCO information for RAN node 804. Accordingly, RAN node 802 may first obtain/generate proposed predicted CCO information for RAN node 804 and send proposed predicted CCO information to RAN node 804. RAN Node 804 may either reject the proposed predicted CCO information and generate revised predicted CCO information and sends the revised predicted CCO information back to RAN node 802 for further negotiation until a final predicted CCO information is determined and provided to RAN node 804 for it to perform the CCO at the future time.

Specifically, in Step 1 of FIG. 8, labeled as 810, RAN node 802 may be configured to send proposed predicted CCO information to RAN node 804 via Message 1. Message 1, for example, may be implemented via the inter-node interface as the RAN NODE CONFIGURATION UPDATE message described above. The proposed predicted CCO information may be included in message 1 in a format or data structure similar to that shown in Table 1 above. Such predicted CCO information may be intended for RAN node 804 to use for performing CCO of its cells.

In Step 2 of FIG. 8, shown as 820, if the RAN node 804 determines that the proposed predicted CCO information as received from RAN node 802 is not reasonable, it may reject the proposed predicted CCO information and generate/obtain/provide at least one of the following information to RAN node 802 via Message 2: recommended/revised predicted CCO information obtained/generated by RAN node 804, and a cause value for the recommendation/revision. The content of the recommended predicted CCO information, for example, may be similar to data structure for predicted CCO information of Table 1 above. The cause value for the recommendation may indicate the reason(s) why RAN node 804 has rejected the proposed predicted CCO information for RAN node 804 by RAN node 802 as received in Message 1 of Step 810. The reasons may be that the proposed predicted information may still have coverage and/or capacity issues in the future time as indicated.

Upon receiving the recommended/revised Predicted CCO Information from the RAN node 804, RAN node 802 may then determine whether the revision is acceptable or further revision of the predicted CCO information is needed, and transmit Message 3 to RAN node 804, as indicated in 830 of FIG. 8. Such negotiation may be performed multiple times or rounds. A final updated/revised predicted CCO information may be provided to RAN node 804 either as an actual revision or as an acknowledgement of recommendation from RAN node 804, as part of Message 3 shown in 830 of FIG. 8. RAN node 804 may then take the final predicted CCO information into consideration to perform optimization of cell coverage and/or capacity of its cells.

In the example implementation of FIG. 8, Message 1 may be implemented as RAN NODE CONFIGURATION UPDATE message or AI/ML CONFIGURATION UPDATE message or AI/ML INFORMATION REQUEST message described above. Accordingly, Message 2 may be implemented as RAN NODE CONFIGURATION UPDATE ACKNOWLEDGE message or AI/ML CONFIGURATION UPDATE ACKNOWLEDGE message or AI/ML INFORMATION RESPONSE message as described above. Message 3 may be implemented as RAN NODE CONFIGURATION UPDATE message or AI/ML CONFIGURATION UPDATE message as described above. Specifically, the RAN nodes 802 and 804 may both be NG-RAN nodes. As such, Message 1 may be implemented as NG-RAN NODE CONFIGURATION UPDATE message or AI/ML CONFIGURATION UPDATE message or AI/ML INFORMATION REQUEST message described above. Accordingly, Message 2 may be implemented as NG-RAN NODE CONFIGURATION UPDATE ACKNOWLEDGE message or AI/ML CONFIGURATION UPDATE ACKNOWLEDGE message or AI/ML INFORMATION RESPONSE message as described above. Accordingly, Message 3 may be implemented as NG-RAN NODE CONFIGURATION UPDATE message or AI/ML CONFIGURATION UPDATE message as described above.

In some other implementations of FIGS. 7 and 8, the first wireless network node may be a DU of a base station and the second wireless network node may be a CU of the base station and the inter-node interface comprises an F1 interface in a control plane.

Inter-Node Transmission of Predicted CCO information Transmission Based on Assistance Information

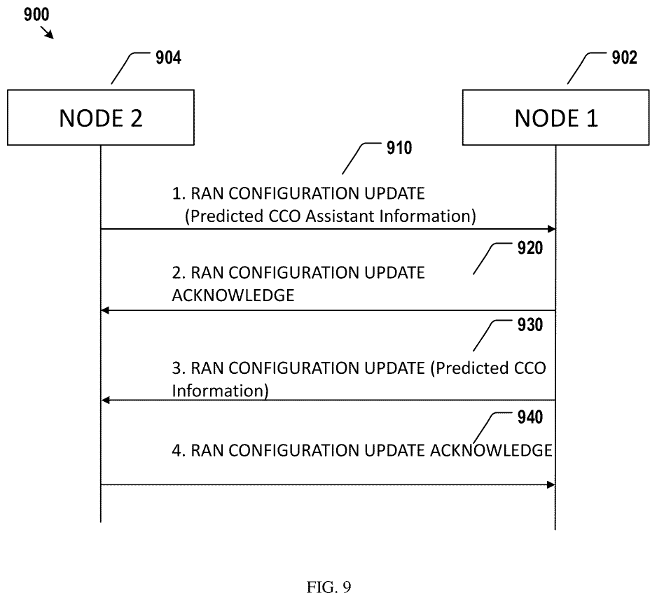

In yet some other example implementations, the inter-node information exchange may involve assistance information for predicting CCO rather than the predict CCO information itself. One such example implementation is shown as procedure 900 in FIG. 9. For example, RAN node 904 may collect and send assistance information for predictive CCO to RAN node 902 to assist RAN node 902 in generating/obtaining predicted CCO information that may be eventually used by RAN node 904 for cell coverage and/or capacity optimization.

Specifically, in Step 1, as shown by 910 of FIG. 9, RAN node 904 may obtain/collect the assistance information for predictive CCO of RAN node 904 to RAN node 902 via, for example, a RAN CONFIGURATION UPDATE message. The assistance information for predictive CCO may include information about, for example, at least one of: a CCO Issue Detection, affected cells and beams, and a Prediction Time. The CCO Issue Detection information, for example, may function as an indicator to specify that the CCO issue is caused by coverage issue or cell edge capacity issue. The Prediction Time provides similar information as in Table 2 above.

In Step 2, as shown by 920 of FIG. 9, RAN node 902 may then send an acknowledgement to RAN node 904 upon receiving the assistance information in 910, via for example, a RAN CONFIGURATION UPDATE ACKNOWLEDGE message.

In Step 3, as shown by 930 of FIG. 9, RAN node 902 may obtain/generate predicted CCO information based on the assistance information received from RAN node 904 in Step 910, and send the predicted CCO information to RAN node 904 via, for example a RAN CONFIGURATION UPDATE message. The predicted CCO information, for example, may include similar data items as indicated in Table 1 above.

In Step 4, as shown by 940 of FIG. 9, RAN node 904 may send a RAN CONFIGURATION UPDATE ACKNOWLEDGE message back to the RAN node 902 upon receiving the predicted CCO information in 930.

With the received predicted CCO information from the RAN node 902, RAN node 904 may then be able to optimize its cell overage or capacity at the specified future prediction time.

In the example implementation above, RAN node 904 may be a gNB-CU node whereas RAN node 902 may be a gNB-DU node. The various RAN messages above may thus be specifically configured as NG-RAN messages. For example, the various message involved above in Step s 910, 920, 930, and 940 may be GNB-CU CONFIGURATION UPDATE, GNB-CU CONFIGURATION UPDATE ACKNOWLEDGE, GNB-DU CONFIGURATION UPDATE, and GNB-DU CONFIGURATION UPDATE ACKNOWLEDGE, respectively. These messages may correspondingly be exchanged via the F1 interface described above, and specifically through F1-C interface. Example constructions of some of these GNB messages are shown in Tables 7-8.

TABLE 7
Example GNB-CU CONFIGURATION UPDATE Message (Node 2 to Node 1)

| | | | | |
|---|---|---|---|---|
| | | | IE type and | |
| IE/Group Name | Presence | Range | reference | Semantics description |

>>Other IEs have been skipped<<

| | | | |
|---|---|---|---|
| Assistance | O | See below | Indicates Predicted CCO Assistance |
| Information for | | in Table 9 | Information for cells and beams |
| Predictive CCO | | | served by the gNB-DU of the same |
| | | | NG-RAN node or for cells and beams |
| | | | not served by the gNB-DU. |

TABLE 8
Example GNB-DU CONFIGURATION UPDATE Message (Node 1 to Node 2)

| | | | | |
|---|---|---|---|---|
| | | | IE type and | |
| IE/Group Name | Presence | Range | reference | Semantics description |

>>Other IEs have been skipped<<

| | | |
|---|---|---|
| Coverage | O | See below |
| Modification | | in Table |
| Notification | | 11 |

The several example information elements contained in the example messages of Tables 7 and 8 are hierarchically shown below in Tables 9-11.

TABLE 9
Example Assistant Information for Predictive CCO of Table 7 (this IE indicates
the Capacity and Coverage (CCO) actions for specific CCO issues detected)

| | | | | |
|---|---|---|---|---|
| | | | IE type and | |
| IE/Group Name | Presence | Range | reference | Semantics description |

| | | | |
|---|---|---|---|
| Predicted CCO | O | ENUMERATED | Indicates the type of |
| issue detection | | (coverage, cell edge | CCO issue detected |
| | | capacity . . . ) | |
| Affected Cells | O | See below in Table | |
| and Beams | | 10 | |
| Prediction Time | O | | The Prediction Time for |
| | | | the CCO assistant |
| | | | information |

TABLE 10
Example Affected Cells and Beams of Table 9 (this IE includes a list of
cells and/or SS/PBCH block indexes affected by the detected CCO issue)

| | | | | |
|---|---|---|---|---|
| | | | IE type and | Semantics |
| IE/Group Name | Presence | Range | reference | description |

| | | | |
|---|---|---|---|
| Affected Cell List | | 1 . . . <maxAffectedCells> | |
| >NR CGI | M | | |
| >Affected SSB List | | 0 . . . <maxnoofSSBAreas> | |
| >>SSB Index | M | | INTEGER |
| | | | (0 . . . 63) |

TABLE 11
Example Coverage Modification Notification Assistant Information of Table
8 (this IE includes a list of cells and/or SS/PBCH block indexes with
the corresponding coverage configuration selected by the gNB-DU)

| | | | IE type and | |
|---|---|---|---|---|
| IE/Group Name | Presence | Range | reference | Semantics description |
| Predicted Coverage | | 1 | | |
| Modification List | | | | |
| >PredictedCoverage | | 1 . . . | | This contains similar |
| Modification Item | | <max_Cells_in_gNBDU> | | information elements as |
| | | | | “PredictedCoverageModi- |
| | | | | fication Item” in Table 1. |

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a first wireless network node, comprising:
obtaining a set of information items for cell coverage and capacity optimization (CCO) at a future time, the set of information items being generated as a prediction based on artificial intelligence (AI); and
transmitting to a second wireless network node, via an inter-node interface for control plane messages, the set of information items for the second wireless network node to change coverage configuration at the future time.

2. The method of claim 1, wherein the set of information items comprise a predicted cell coverage modification list, the predicted cell coverage modification list specifying one or more predicted cell coverage modification items each comprising at least one of:
a predicted cell coverage state;
a prediction Time;
a global cell identifier;
a predicted synchronization signal block (SSB) coverage modification list; and
a cell coverage modification Cause.

3. The method of claim 2, wherein at least one of the one or more predicted cell coverage modification items comprises the predicted SSB coverage modification list, the predicted SSB modification list comprising one or more SSB coverage modification items.

4. (canceled)

5. The method of claim 2, wherein the set of information items are transmitted by the first wireless network node to the second wireless network node in a radio access node (RAN) configuration update message via the inter-node interface.

6. The method of claim 5, wherein:
the first wireless network node and the second wireless network node each comprise a next-generation radio access network (NG-RAN) node and the inter-node interface comprises an Xn interface in a control plane; or
the first wireless network node comprises a distributed-unit (DU) of a gNB and the second wireless network node comprises a central-unit (CU) of the gNB and the inter-node interface comprises an F1 interface in a control plane.

7. (canceled)

8. The method of claim 5, further comprising receiving, via the inter-node interface, a RAN configuration update acknowledge message or a GNB-DU configuration update acknowledge message from the second wireless network node.

9-15. (canceled)

16. (canceled)

17. (canceled)

18. (canceled)

19. (canceled)

20. The method of claim 1, wherein obtaining the set of information items is in response to receiving a predicted CCO assistant information items from the second wireless network node.

21. The method of claim 20, wherein the predicted CCO assistance information items comprise at least one of:
predicted CCO issue detection information;
information on affected cells and beams; and
a prediction time.

22-25. (canceled)

26. (canceled)

27. (canceled)

28. The method of claim 3, wherein the one or more SSB coverage modification items comprises at least one of the following:
a SSB index; and
a predicted SSB coverage state.

29. A first wireless network node comprising:
a memory storing instructions; and
at least one processor in communication with the memory, wherein, when the at least one processor executes the instructions, the at least one processor is configured to cause the first wireless network node to perform:
obtaining a set of information items for cell coverage and capacity optimization (CCO) at a future time, the set of information items being generated as a prediction based on artificial intelligence (AI), and
transmitting to a second wireless network node, via an inter-node interface for control plane messages, the set of information items for the second wireless network node to change coverage configuration at the future time.

30. The first wireless network node according to claim 29, wherein the set of information items comprise a predicted cell coverage modification list, the predicted cell coverage modification list specifying one or more predicted cell coverage modification items each comprising at least one of:
a predicted cell coverage state;
a prediction Time;
a global cell identifier;
a predicted synchronization signal block (SSB) coverage modification list; and
a cell coverage modification Cause.

31. The first wireless network node of claim 30, wherein at least one of the one or more predicted cell coverage modification items comprises the predicted SSB coverage modification list, the predicted SSB modification list comprising one or more SSB coverage modification items.

32. The first wireless network node of claim 31, wherein the one or more SSB coverage modification items comprises at least one of the following:
a SSB index; and
a predicted SSB coverage state.

33. The first wireless network node of claim 31, wherein the set of information items are transmitted by the first wireless network node to the second wireless network node in a radio access node (RAN) configuration update message via the inter-node interface.

34. The first wireless network node of claim 33, wherein:
the first wireless network node and the second wireless network node each comprise a next-generation radio access network (NG-RAN) node and the inter-node interface comprises an Xn interface in a control plane; or
the first wireless network node comprises a distributed-unit (DU) of a gNB and the second wireless network node comprises a central-unit (CU) of the gNB and the inter-node interface comprises an F1 interface in a control plane.

35. The first wireless network node of claim 33, wherein, when the at least one processor executes the instructions, the at least one processor is configured to cause the first wireless network node to further perform:
receiving, via the inter-node interface, a RAN configuration update acknowledge message or a GNB-DU configuration update acknowledge message from the second wireless network node.

36. The first wireless network node of claim 29, wherein obtaining the set of information items is in response to receiving a predicted CCO assistant information items from the second wireless network node.

37. The first wireless network node of claim 36, wherein the predicted CCO assistance information items comprise at least one of:
predicted CCO issue detection information;
information on affected cells and beams; and
a prediction time.

38. A non-transitory computer-readable medium storing instructions, wherein, the instructions, when executed by a first wireless network node, are configured to cause the first wireless network node to perform:
obtaining a set of information items for cell coverage and capacity optimization (CCO) at a future time, the set of information items being generated as a prediction based on artificial intelligence (AI), and
transmitting to a second wireless network node, via an inter-node interface for control plane messages, the set of information items for the second wireless network node to change coverage configuration at the future time.

39. The non-transitory computer-readable medium of claim 38, wherein the set of information items comprise a predicted cell coverage modification list, the predicted cell coverage modification list specifying one or more predicted cell coverage modification items each comprising at least one of:
a predicted cell coverage state;
a prediction Time;
a global cell identifier;
a predicted synchronization signal block (SSB) coverage modification list; and
a cell coverage modification Cause.
